(19) United States
(12) Patent Application Publication
(10) Pub. No.: US 2005/0282039 A1
(43) Pub. Date: Dec. 22, 2005

(54) Recording and reproducing apparatus having magnetic recording medium possessing a specific range of surface resistivity for GMR head

(75) Inventors: Hiroki Tetsukawa, Kanagawa (JP); Tadashi Ozue, Kanagawa (JP); Yutaka Souda, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 11/209,378

(22) Filed: Aug. 23, 2005

Related U.S. Application Data
(63) Continuation of application No. 10/368,730, filed on Feb. 18, 2003.

(30) Foreign Application Priority Data
Feb. 18, 2002 (JP) P2002-040488

(51) Int. Cl. G11B 5/127

(52) U.S. Cl. 428/836.1

(57) ABSTRACT

Disclosed is a magnetic recording medium, which comprises a metal magnetic thin film formed on a nonmagnetic support member, surface resistivity of the metal magnetic thin film is in the range of 1×10³ Ω/sq.-1×10⁷ Ω/sq., a value of Mr·t (a product of amount of residual magnetization (Mr) and film thickness (t)) is within the range of 4 mA-13 mA, and amount of residual magnetization (Mr) is within the range of 160 kA/m-360 kA/m. As a result, in the reproduction using GMR head, it is possible to suppress noise and to prevent saturation of GMR head and electrostatic destruction.

### BACKGROUND OF THE INVENTION

1. Field of the Invention

The present invention relates to a magnetic recording medium of the so-called metal magnetic thin film type. In particular, the invention relates to a tape shaped magnetic recording medium suitable for the use in a helical scan magnetic recording and reproducing system using a reproduction head of giant magnetic resistance effect (GMR) type.

2. Description of Related Art

The so-called coating type magnetic recording medium has been widely used. To make this type of magnetic recording medium, powder magnetic material such as oxide magnetic powder or alloy magnetic powder is dispersed in an organic binder such as vinyl chloride-vinyl acetate copolymer, polyester resin, polyurethane resin etc., and a magnetic coating material thus prepared is coated on a nonmagnetic support member and is dried.

In contrast, with the increasing demand on the execution of high-density recording, a magnetic recording medium of the so-called metal magnetic thin film type has been proposed and attention is now focused on it. To make this type of magnetic recording medium, a metal magnetic material such as Co—Ni, Co—Cr, Co, etc. is directly attached on a nonmagnetic support member by plating or by vacuum thin film forming means (such as vacuum deposition method, sputtering method, ion plating method)

The magnetic recording medium of the metal magnetic thin film type has high coercive force, high residual magnetization, and high angular ratio. It has superb electromagnetic transfer characteristics in short wavelength, and the thickness of the magnetic layer can be made very thin. As a result, it is advantageous in that loss due to thickness is low during demagnetization of recording or reproduction. There is no need to intermingle a binder, i.e. a nonmagnetic material, into the magnetic layer, and filling density of the magnetic material can be increased and higher magnetization can be attained.

Further, the so-called diagonal vacuum deposition has been proposed to perform vacuum deposition on the magnetic layer in diagonal direction during the formation of the magnetic layer of the magnetic recording medium for the purpose of improving electromagnetic transfer characteristics of the magnetic recording medium of this type and to provide higher output. The magnetic recording medium of this type is now practically used as a magnetic tape for high image quality VTR or for digital VTR.

Further, in recent years, with the rapid increase in the amount of information to be handled, there are strong demands on the improvement of recording density, and there is a tendency to shift toward MR head, which has higher detection sensitivity than inductive head (induction type magnetic head). For the purpose of achieving high recording density, it is now indispensable to adopt a GMR head, which comprises a spin valve element.

However, there are problems in that the GMR head has high sensitivity and there are problems of noise, saturation of head and ESD (electrostatic destruction). The tapes originally designed for the conventional type inductive head or MR head have higher noise and high amount of residual magnetization, and this leads to saturation of the head. Further, electric charging on the tape surface may lead to electrostatic destruction of GMR head.

### SUMMARY OF THE INVENTION

To overcome the problems as described above, it is an object of the present invention to provide a magnetic recording medium, by which it is possible to suppress noise, and to prevent saturation of GMR head and electrostatic destruction.

According to one aspect of the present invention, the magnetic recording medium comprises a metal magnetic thin film formed on a nonmagnetic support member, surface resistivity of the metal magnetic thin film is in the range of 1×10³ Ω/sq.-1×10⁷ Ω/sq., a value of Mr·t (a product of amount of residual magnetization (Mr) and film thickness (t)) is within the range of 4 mA-13 mA, and amount of residual magnetization (Mr) is within the range of 160 kA/m-360 kA/m.

In the magnetic recording medium according to the present invention as described above, surface resistivity is limited to the range as given above, and electric charging or flow of electric current on the surface of the metal magnetic thin film can be suppressed. Also, in this magnetic recording medium, the value of Mr·t, i.e., a product of amount of residual magnetization (Mr) and film thickness (t), is limited to the above range. As a result, there is no distortion in reproduction waveform, and reproduction output is increased. Also, the amount of residual magnetization (Mr) is limited as given above. Thus, noise is reduced and sufficient reproduction output can be attained.

Other and further objects, features and advantages of the invention will appear more fully from the following description.

### BRIEF DESCRIPTION OF THE DRAWINGS

FIG. 1 is a cross-sectional view of an arrangement example of a magnetic recording medium of the present invention;

FIG. 2 is a perspective view schematically showing a rotary drum unit;

FIG. 3 is a plan view schematically showing a magnetic tape feeding mechanism including the rotary drum unit;

FIG. 4 is a partially cutaway perspective view showing an arrangement example of a GMR head; and

FIG. 5 is a schematical perspective view showing how a magnetic tape is moved by sliding along a GMR element.

### DETAILED DESCRIPTION OF THE PREFERRED EMBODIMENTS

Detailed description will be given below on embodiments of a magnetic recording medium of the present invention referring to the drawings.

As shown in FIG. 1, a magnetic recording medium 1 according to the present invention comprises a magnetic layer 3, which contains a metal magnetic thin film formed on a tape shaped nonmagnetic support member 2.

As the nonmagnetic support member 2, polyesters such as polyethylene terephthalate, polyethylene-2,6-naphthalate, etc., polyolefins such as polypropylene, cellulose derivatives such as cellulose triacetate, cellulose diacetate, etc., polyamide, aramide resin, plastics such as polycarbonate, etc. may be used. The nonmagnetic support member may be designed in a single-layer structure or in a multi-layer structure. Also, the surface of the nonmagnetic support member may be processed by surface treatment such as corona discharge treatment, or a layer of organic substance such as easily adhesive layer may be formed on it.

The magnetic layer 3 is produced by attaching a metal magnetic thin film using conventionally known methods such as vacuum deposition method, sputtering method, chemical vapor deposition (CVD) method, ion plating method, etc. Above all, it is preferable to use a film formed by vacuum deposition method as the metal magnetic thin film. The thickness of the metal magnetic thin film can be controlled by changing line speed, and amount of residual magnetization can be controlled by changing the amount of oxygen introduced during vacuum deposition. For instance, it is possible to reliably form a metal magnetic thin film of 15-40 nm in thickness.

The metal magnetic thin film of the magnetic layer 3 may be formed on a Cr primer layer. CrTi, CrMo, CrV, etc. may be used as the primer layer in addition to Cr.

In the magnetic recording medium 1 of the present invention, the value of Mr·t, i.e. a product of amount of residual magnetization (Mr) and film thickness (t), should be within the range of 4 mA-13 mA. If the value of Mr·t of the magnetic recording medium 1 is higher than 13 mA, GMR head may be saturated, and MR resistance change may be turned to out of linear range, and reproduction waveform may be distorted. When the value of Mr·t is smaller than 4 mA, reproduction output is decreased, and satisfactory S/N ratio (signal/noise ratio) cannot be attained. Therefore, by limiting the value of Mr·t within the range of 4 mA-13 mA, it is possible to obtain a magnetic recording medium, which has no distortion in the reproduction waveform and provides high reproduction output and satisfactory S/N ratio.

The values of Mr and t can be controlled by adjusting conditions such as amount of oxygen introduced during vacuum deposition and feeding speed of the nonmagnetic support member. Specifically, if the amount of oxygen introduced during vacuum deposition is decreased, the value of Mr is increased. If the amount of oxygen introduced is increased, the value of Mr is decreased. If the feeding speed of the nonmagnetic support member during vacuum deposition is slowed down, the value of t is increased. If the feeding speed is increased, the value of t will be thinner. Also, the value of Mr can be adjusted by surface oxidizing processing after the formation of the magnetic layer.

In this case, it is preferable that the value of Mr, i.e. amount of residual magnetization, is within the range of 160-360 kA/m. If the value of Mr is higher than 360 kA/m, magnetic particles cannot be separated from each other, and noise is increased due to magnetic interaction between the particles. If the value of Mr is smaller than 160 kA/m, oxidation of Co particles occurs, and sufficient reproduction output cannot be attained. Therefore, by adjusting the value of Mr within the range of 160-360 kA/m, it is possible to decrease noise and to provide sufficient reproduction output. More preferably, the value of Mr is within the range of 200-340 kA/m.

In the magnetic recording medium of the present invention, it is preferable that surface resistivity is within the range of 1×10³ Ω/sq.-1×10⁷ Ω/sq. If surface resistivity is higher than 1×10⁷ Ω/sq. high electric charge may be applied to tape surface during the running operation of the magnetic tape, and ESD destruction (electrostatic destruction) may occur when the tape is brought into contact with GMR head. If surface resistivity is lower than 1×10³ Ω/sq., electric charge is more easily applied to the surface of the medium. When the medium is brought into contact with GMR head, electric current flows rapidly, and ESD destruction may occur. Therefore, by adjusting surface resistivity within the range of 1×10³ Ω/sq.-1×10⁷ Ω/sq., electrical charging or flow of electric current to the surface of the metal magnetic thin film can be controlled, and electrostatic destruction of GMR head can be prevented.

The surface resistivity can be adjusted by controlling thickness of diamond-like carbon (DLC), which is formed on the metal magnetic thin film.

It is preferable that the thickness t of the metal magnetic thin film is within the range of 15 nm-40 nm. By adjusting the value of t as described above, the values of Mr·t, Mr, and surface resistivity of the magnetic recording medium of the present invention can be controlled within the above range.

Further, in the magnetic recording medium 1, it is preferable that coercive force Hc in in-plane direction is within the range of 100 kA/m-160 kA/m. If coercive force is lower than 100 kA/m, it is not possible to attain low noise and high S/N ratio. If coercive force exceeds 160 kA/m, sufficient recording cannot be achieved, and reproduction output is decreased. Accordingly, by adjusting coercive force in in-plane direction in the range of 100 kA/m-160 kA/m, it is possible to attain low noise and high S/N ratio and to provide high reproduction output.

In the magnetic recording medium 1 according to the present invention, a protective layer may be formed on the surface of the magnetic layer, while there is no special restriction to the material, and any type of material may be used, which can be used as a protective film for normal metal magnetic thin film. For example, diamond-like carbon (DLC), CrO₂, Al₂O₃, BN, Co oxide, MgO, SiO₂, Si₃O₄, SiNx, SiC, SiNx-SiO₂, ZrO₂, TiO₂, TiC, etc. may be used. The protective film may be a single film consisting of these materials or it may be a multi-layer film or a composite film.

It is needless to say that the magnetic recording medium 1 is not limited to the above. An undercoating layer may be formed on the nonmagnetic support member when necessary, or a back-coating layer may be arranged on the surface of the nonmagnetic support member opposite to the surface where the metal magnetic thin film is formed. Or, a top coating layer comprising a lubricant or a rust-preventive agent may be formed on the surface of the metal magnetic thin film or the protective film. Further, a plurality of magnetic layers may be laminated as the magnetic recording medium 1. Also, the magnetic recording medium 1 may be designed in disk-like shape having vertical anisotropy or in-plane random orientation.

In the magnetic recording medium 1 of the present invention with the above arrangement, the value of Mr·t, i.e. a product of amount of residual magnetization (Mr) and film thickness (t), is controlled within the range of 4 mA-13 mA. Thus, there is no distortion in reproduction waveform. Reproduction output is high, and satisfactory S/N ratio can be achieved. Also, in the magnetic recording medium 1, the value of Mr is adjusted within the range of 160 kA/m-360 kA/m. As a result, noise can be reduced, and sufficient reproduction output can be provided. In the magnetic recording medium 1, surface resistivity of the magnetic metal thin film is adjusted within the range of 1×10³ Ω/sq.-1×10⁷ Ω/sq. This makes it possible to suppress electric charging or flow of electric current on the surface of the metal magnetic thin film, and electrostatic destruction of GMR head can be prevented.

As a result, in the magnetic recording medium 1 of the present invention, noise can be suppressed and high reproduction output and satisfactory S/N ratio can be provided. Also, saturation of the head and electrostatic destruction are avoided when reproduction is performed with high-sensitivity GMR head, and a superb magnetic recording medium suitable for reproduction with the high-sensitivity GMR head can be obtained.

The magnetic recording medium 1 as described above is particularly suitable as a magnetic tape in a helical scan magnetic recording system using GMR reproduction head. By using the magnetic recording medium 1 in a helical scan system equipped with GMR head, which comprises a spin valve element, it is possible to attain low noise and high S/N ratio without saturating GMR head. Further, the magnetic tape can be driven without causing ESD destruction (electrostatic destruction) on GMR head.

In this case, it is preferable that a shield-type GMR head having GMR element sandwiched by shields may be used as GMR reproduction head and a recording and reproducing system is constructed by arranging this on a rotary drum. By combining the helical scan magnetic recording system using GMR reproduction head with the magnetic recording medium 1 of the present invention, it is possible to produce a high-density recording system, which has not been known in the past.

The magnetic recording and reproducing device of the helical scan magnetic recording system is a magnetic recording and reproducing device of helical scan type for performing the recording and the reproduction by the use of a rotary drum. MR head is used as a magnetic head for reproduction provided in the rotary drum.

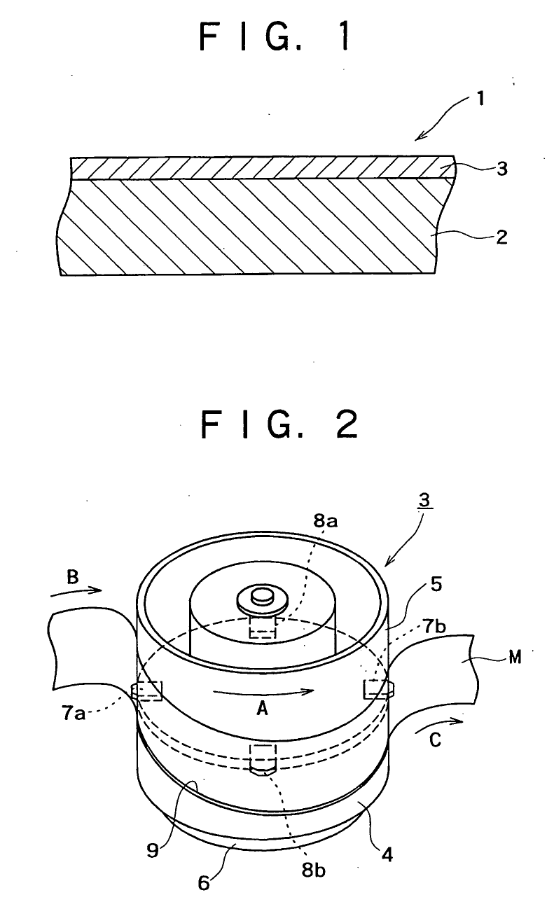

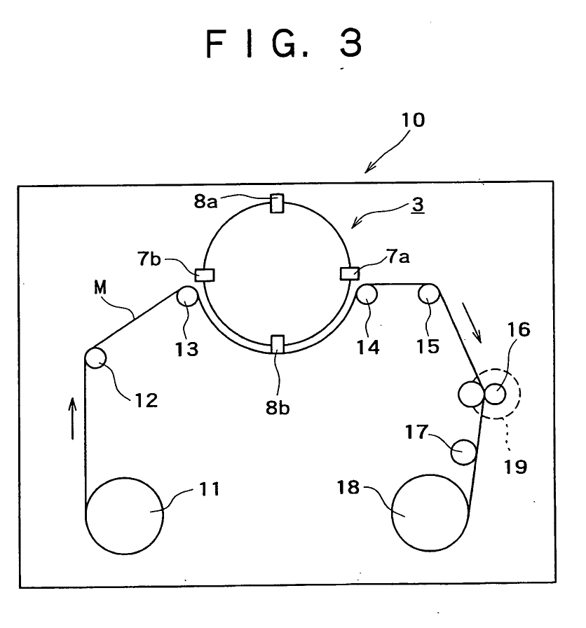

FIG. 2 and FIG. 3 each represents an arrangement example of a rotary drum unit to be mounted on the magnetic recording and reproducing device. FIG. 2 is a perspective view, schematically showing a rotary drum unit 3, and FIG. 3 is a plan view of a magnetic tape feeding mechanism 10 including the rotary drum unit 3.

As shown in FIG. 2, the rotary drum unit 3 comprises a stationary drum 4 in cylindrical shape, a rotary drum 5 in cylindrical shape, a motor 6 for rotating and driving the rotary drum 5, a pair of inductive type magnetic heads 7a and 7b mounted on the rotary drum 5, and a pair of GMR heads 8a and 8b mounted on the rotary drum 5.

The stationary drum 4 is a drum to be held without being rotated. On a side of this stationary drum 4, a leading guide unit 9 is provided along the running direction of a magnetic tape M. As to be described later, the magnetic tape M is driven along the leading guide unit 9 during reproduction of the recorded information. The rotary drum 5 is arranged in such manner that its central axis concurs with that of the stationary drum 4.

The rotary drum 5 is a drum, which is rotated and driven at a predetermined rotating speed by the motor 6 during reproduction of the recorded information on the magnetic tape M. The rotary drum 5 is designed in form of a cylinder having the same diameter as the stationary drum 4, and its central axis concurs with that of the stationary drum 4. On a side of the rotary drum 5 facing to the stationary drum 4, a pair of inductive type magnetic heads 7a and 7b and a pair of GMR heads 8a and 8b are mounted.

The inductive type magnetic heads 7a and 7b each comprises a pair of magnetic cores connected via a magnetic gap and have coils wound on the magnetic cores. The head is used when signals are recorded on the magnetic tape M. These inductive type magnetic heads 7a and 7b are mounted on the rotary drum 5 in such manner that the magnetic heads make an angle of 180° to each other with respect to the center of the rotary drum 5 and a part of the magnetic gap protrudes from outer periphery of the rotary drum 5. These inductive type magnetic heads 7a and 7b are designed to have azimuth angles opposite to each other in order to perform azimuth recording on the magnetic tape M.

On the other hand, GMR heads 8a and 8b are magnetic heads for reproduction having a spin valve element as a magneto-sensitive element to detect signals from the magnetic tape M, and these heads are used when the signals from the magnetic tape M are reproduced. These GMR heads 8a and 8b make an angle of 180° to each other with respect to the center of the rotary drum 5 and are mounted on the rotary drum so that a part of magnetic gap portion protrudes from outer periphery of the rotary drum. These GMR heads are designed to have azimuth angles opposite to each other in order to reproduce the signals of azimuth recording on the magnetic tape M.

The magnetic recording and reproducing device records signals on the magnetic tape M or reproduces signals from the magnetic tape M by moving the magnetic tape M to slide along the rotary drum unit 3.

Specifically, as shown in FIG. 3, the magnetic tape M is sent from a supply reel 11 via guide rollers 12 and 13 to be wound up on the rotary drum unit 3 during the reproduction of the recorded information, and the recorded information is reproduced by the rotary drum 3. After the recorded information is reproduced by the rotary drum unit 3, the magnetic tape M is sent to a take-up roll 18 via guide rollers 14 and 15, a capstan 16, and a guide roller 17. That is, the magnetic tape M is sent at a predetermined tension and speed by the capstan 16, which is rotated and driven by a capstan motor 19, and it is wound up on the take-up roll 18 via the guide roller 17.

In this case, the rotary drum 5 is rotated and driven by the motor 6 as shown by an arrow A in FIG. 2. On the other hand, the magnetic tape M is sent along the leading guide unit 9 of the stationary drum 4 to slide diagonally with respect to the stationary drum 4 and the rotary drum 5. Specifically, the magnetic tape M is sent in running direction of the tape along the leading guide unit 9 so that it is in sliding contact with the stationary drum 4 and with the rotary drum 5 from tape inlet side as shown by an arrow B in FIG. 2. Then, the tape is sent toward tape outlet as shown by an arrow C in FIG. 2.

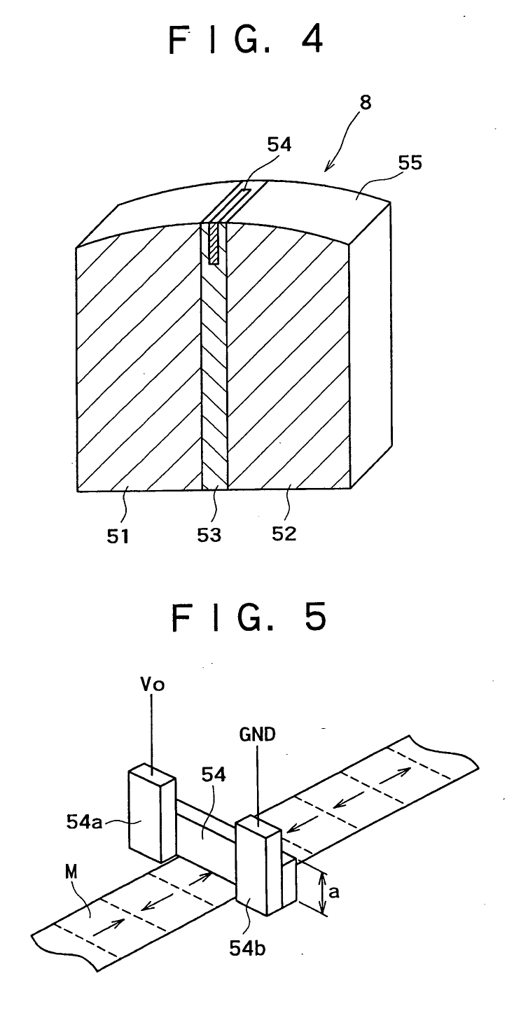

Next, detailed description will be given on GMR heads 8a and 8b mounted on the rotary drum 3 referring to FIG. 4 and FIG. 5. GMR head 8a and GMR head 8b are arranged in the same manner except that these have azimuth angles opposite to each other. In this respect, GMR heads 8a and 8b are referred hereinafter together as GMR head 8.

The GMR head 8 is a magnetic head mounted on the rotary drum 3 and exclusively used for reproduction of signals from the magnetic tape by helical scan system. In general, GMR head 8 has higher sensitivity and higher reproduction output than an inductive type magnetic head or an anisotropic magnetic resistance effect type magnetic head for reproducing the recorded information by electromagnetic induction, and it is more suitable for high-density recording. Therefore, by using the GMR head 8 as a magnetic head for reproduction, high-density recording can be achieved.

As shown in FIG. 4, the GMR head 8 comprises a pair of magnetic shields 51 and 52 made of soft magnetic material such as Ni—Zn polycrystal ferrite and a GMR element unit 54 of approximately rectangular shape squeezed by the pair of magnetic shields 51 and 52 via an insulating member 53. A pair of terminals is led out from both ends of the GMR element unit 54 respectively, and sense current is supplied to the GMR element unit 54 via these terminals.

The GMR element unit 54 has a spin valve element, which comprises a free magnetization layer for changing direction of magnetization with respect to external magnetic field and a fixed magnetization layer for fixed magnetization, both layers being laminated one upon another via a nonmagnetic layer. In the spin valve element, an anti-ferromagnetic layer for fixing magnetization of the fixed magnetization layer is laminated on the fixed magnetization layer.

The GMR element unit 54 is designed in approximately rectangular shape, and it is squeezed by a pair of magnetic shields 51 and 52 via the insulating member 53 so that one surface of the GMR element unit is exposed on a magnetic tape sliding surface 55. Describing in more detail, the GMR element unit 54 is squeezed by the pair of magnetic shields 51 and 52 via the insulating member 53 so that shorter axis of the GMR element unit 54 runs approximately perpendicularly to the magnetic tape sliding surface 55, and its longer axis runs approximately perpendicularly to sliding direction of the magnetic tape.

The magnetic tape sliding surface 55 of the GMR head 8 is polished by cylindrical polishing along sliding direction of the magnetic tape M so that one side of the GMR element unit 54 is exposed on the magnetic tape sliding surface 55, and it is polished by cylindrical polishing along a direction perpendicular to the sliding direction of the magnetic tape M. As a result, the GMR head 8 is designed in such manner that the GMR element unit 54 or a portion closer to it is protruded maximum from the drum surface. By designing in such manner, the GMR element 54 is kept in touch satisfactorily with the magnetic tape M.

When signals from the magnetic tape M are reproduced by using the GMR head 8 as described above, the magnetic tape M is moved to slide on GMR element unit 54 as shown in FIG. 5. Arrows in FIG. 5 schematically show how the magnetic tape M is magnetized.

Under the condition that the magnetic tape M is sliding along the GMR element unit 54, the sense current is supplied to the GMR element unit 54 via terminals 54a and 54b connected to both ends of the GMR element unit 54, and the voltage change of the sense current is detected.

Specifically, when the sense current is supplied to the GMR element unit 54 with the magnetic tape M sliding on it, direction of magnetization of the free magnetization layer is changed according to the magnetic field from the magnetic tape M, and relative angle between the direction of magnetization of the fixed magnetization layer and the direction of magnetization of the free magnetization layer is changed. In this case, the sense current supplied to the GMR element unit 54 has its resistance value changed depending on relative angle between the direction of magnetization of the fixed magnetization layer and the direction of magnetization of the free magnetization layer. In this respect, if the value of the sense current supplied to the GMR element unit 54 is maintained at a constant level, voltage change occurs in the sense current when the resistance value in the spin valve element is changed. By detecting the voltage change in the sense current, magnetic field of the signal from the magnetic tape M is detected, and a signal recorded on the magnetic tape M is reproduced.

In the magnetic tape M according to the present invention, the value of Mr·t, i.e. a product of amount of residual magnetization (Mr) and film thickness (t), is controlled within the range of 4 mA-13 mA. Thus, there is no distortion in the reproduction waveform. Reproduction output is high, and S/N ratio is satisfactory. In this magnetic tape M, the value of Mr is adjusted within the range of 160 kA/m-360 kA/m. As a result, noise is reduced, and sufficient reproduction output is provided. In this magnetic tape, surface resistivity of the magnetic metal thin film is limited within the range of 1×10³ Ω/sq.-1×10⁷ Ω/sq. As a result, it is possible to suppress electric charging or flow of electric current on the surface of the metal magnetic thin film and to prevent electrostatic destruction of the GMR head.

Specifically, in this magnetic tape, noise is reduced, and high reproduction output and satisfactory S/N ratio can be provided. Saturation of the head and electrostatic destruction are prevented when the signals are reproduced by the high-sensitivity GMR head, and it is a superb magnetic recording medium suitable for the reproduction on the high-sensitivity GMR head.

### EXAMPLES

Next, description will be given on several examples to confirm and demonstrate the effects of the present invention. In the examples given below, concrete material name and numerical values are given, while it is needless to say that the present invention is not limited to these materials or numerical values.

<Experiment of the Value of Mr·t—a Product of Amount of Residual Magnetization (Mr) and Film Thickness (t)>

### Example 1

First, a polyethylene terephthalate film of 10 μm in thickness and 150 mm in width was prepared. On the surface of this film, water-soluble latex containing acryl ester as main component was coated to have density of 10,000,000/mm², and an undercoating layer was formed.

Then, a metal magnetic thin film of Co—O type was formed by vacuum deposition method. Film-forming conditions were as follows:

(Film-Forming Conditions)

Degree of vacuum during vacuum deposition: 7×10⁻² Pa
Ingot: Co
Incident angle: 45°-90°
Introduced gas: Oxygen gas

By this vacuum deposition method, a Co—O type metal magnetic thin film was formed to have film thickness of 35 nm. After the metal magnetic thin film was formed, a carbon film in thickness of about 10 nm was formed on the magnetic layer thus prepared by sputtering or CVD method.

Then, on the surface of the nonmagnetic support member opposite to the surface where the magnetic layer was formed, a back-coating layer comprising carbon and urethane resin was formed in thickness of 0.6 μm. On the surface of carbon film, a lubricant comprising perfluoro-polyether was coated. Then, this was cut off to 8 mm in width. Under the atmospheric air, the surface of the magnetic layer was oxidized by maintaining this at normal temperature for a predetermined period of time and a magnetic tape was prepared.

In the magnetic tape thus prepared, amount of residual magnetization (Mr) was 285 mA/m. The thickness (t) of the metal magnetic thin film was 35 nm. The product (Mr·t) was 10 mA.

### Examples 2-5 and Comparative Examples 1 and 2

A magnetic tape was prepared by the same procedure as in Example 1 except that the amount of residual magnetization (Mr) was controlled by adjusting the amount of introduced oxygen during vacuum deposition of the metal magnetic thin film and by adjusting the retention time in the atmospheric air after the formation of the metal magnetic thin film, and the product (Mr·t) was changed as shown in Table 1.

To the magnetic tape thus prepared, electromagnetic transfer characteristics were measured. More concretely, a product modified from 8-mm VTR was used. Information signals were recorded on each of sample tapes at recording wavelength of 0.5 μm. Then, reproduction output, noise level, and error ratio were measured using the shield type GMR head.

A shield type GMR head was used, which comprises a free layer and a spin layer containing NiFe, an anti-ferromagnetic layer comprising PtMn, and a nonmagnetic layer containing Cu, and which has a spin valve element having resistance change ratio of about 5%.

On the magnetic tapes of Examples 1-5 and Comparative Examples 1 and 2, reproduction output, noise level, and C/N were measured. Further, measurement and evaluation were made on surface resistivity of the metal magnetic thin film and electrostatic destruction of the GMR head. The results are shown in Table 1.

In the evaluation of electrostatic destruction, the case where electrostatic destruction did not occur during running operation of the tape was defined as ◯, and the case where electrostatic destruction occurred was defined as X.

TABLE 1

| | | | | | Surface | |
|---|---|---|---|---|---|---|
| | Mr · t | Reproduction | Noise | | Resistivity | |
| | [mA] | output [dB] | [dB] | C/N | [Ω/sq.] | ESD |
| Example 1 | 10 | 9.1 | 6.9 | 2.2 | 5E+04 | ∘ |
| Example 2 | 4 | 0.0 | 0.0 | 0.0 | 1E+07 | ∘ |
| Example 3 | 6 | 5.3 | 4.5 | 0.8 | 3E+06 | ∘ |
| Example 4 | 12 | 9.9 | 8.2 | 1.7 | 3E+03 | ∘ |
| Example 5 | 13 | 10.1 | 9.2 | 0.9 | 1E+03 | ∘ |
| Comparative | 3 | −5.9 | −3.9 | −2.0 | 6E+08 | x |
| Example 1 | | | | | | |
| Comparative | 15 | 10.7 | 11.5 | −0.8 | 7E+02 | x |
| Example 2 | | (Distortion) | | | | |

As it is evident from Table 1, in the Comparative Example 1 with the value of Mr·t lower than 4 mA, reproduction output is low, and S/N ratio is not satisfactory. In Comparative Example 2 with the value of Mr·t greater than 13 mA, GMR head is saturated, and distortion occurs in reproduction output. On the other hand, in Example 1-5 with the value of Mr·t in the range of 4 mA-13 mA, there is no distortion. Reproduction output is high, and S/N ratio is satisfactory.

Regarding surface resistivity of the metal magnetic thin film, electrostatic destruction occurs in the head in Comparative Example 1 with surface resistivity higher than 1×10⁷ Ω/sq. or in Comparative Example 2 with surface resistivity lower than 1×10³ Ω/sq. On the other hand, in Examples 1-5, in which surface resistivity is in the range of 1×10³ Ω/sq.-1×10⁷ Ω/sq., electric charging or flow of electric current on the surface of the metal magnetic thin film is suppressed and electrostatic destruction of the head is prevented.

<Experiment on Amount of Residual Magnetization Mr>

### Examples 6-10 and Comparative Examples 3 and 4

Magnetic tapes were prepared by the same procedure as in Example 1 except that the amount of residual magnetization (Mr) was changed as shown in Table 2 by adjusting the retention time in the atmospheric air after the formation of the metal magnetic thin film.

On the magnetic tapes of Examples 6-10 and Comparative Examples 3 and 4, reproduction output, noise level, and C/N were measured by the methods as described above.

TABLE 2

| | Mr | Reproduction | Noise | |
|---|---|---|---|---|
| | [kA/m] | output [dB] | [dB] | C/N |
| Example 6 | 160 | 0.0 | 0.0 | 0.0 |
| Example 7 | 200 | 5.3 | 4.3 | 1.0 |
| Example 8 | 285 | 9.1 | 6.9 | 2.2 |
| Example 9 | 340 | 9.6 | 7.8 | 1.8 |
| Example 10 | 360 | 9.8 | 9.6 | 0.2 |
| Comparative | 140 | −6.3 | −4.0 | −2.3 |
| Example 3 | | | | |
| Comparative | 390 | 10.9 | 11.8 | −0.9 |
| Example 4 | | (Distortion) | | |

As it is apparent from Table 2, in Comparative Example 3 with the value of Mr lower than 160 kA/m, sufficient reproduction output is not obtained. In Comparative Example 4 with the value of Mr higher than 360 kA/m, noise is increased. In contrast, in Examples 6-10 having the value of Mr within the range of 160 kA/m-360 kA/m, noise is suppressed, and sufficient reproduction output is obtained. Above all, in Examples 7-9 having the value of Mr in the range of 200 kA/m-340 kA/m, the characteristics are very satisfactory.

<Experiment on In-Plane Coercive Force Hc>

### Examples 11-14 and Comparative Examples 5 and 6

Magnetic tapes were prepared by the same procedure as in Example 1 except that the in-plane coercive force Hc was changed as shown in Table 3 by adjusting the amount of introduced oxygen during vacuum deposition of the metal magnetic thin film and by adjusting the retention time in the atmospheric air after preparation of the metal magnetic thin film and combination of these values.

On the magnetic tapes prepared in Examples 11-14 and Comparative Examples 5 and 6, reproduction output, noise level, and C/N were measured by the methods as described above. The results are shown in Table 3.

TABLE 3

| | Hc | Reproduction | Noise | |
|---|---|---|---|---|
| | [kA/m] | output [dB] | [dB] | C/N |
| Comparative | 90 | −0.3 | 2.1 | −2.4 |
| Example 5 | | | | |
| Example 11 | 100 | 0.0 | 0.0 | 0.0 |
| Example 12 | 120 | 0.3 | −1.6 | 1.9 |
| Example 13 | 150 | 0.3 | −0.9 | 1.2 |
| Example 14 | 160 | 0.2 | −0.4 | 0.6 |
| Comparative | 180 | −1.1 | 0.9 | −2.0 |
| Example 6 | | | | |

As it is apparent from Table 3, in Comparative Example 5 having coercive force lower than 100 kA/m, noise is increased, and S/N ratio is not sufficiently high. In Comparative Example 5 having coercive force higher than 160 kA/m, reproduction output is decreased. In contrast, in Examples 11-14 having in-plane coercive force within the range of 100 kA/m-160 kA/m, noise is suppressed, and S/N ratio and reproduction output are high.

The foregoing invention has been described in terms of preferred embodiments. However, those skilled, in the art will recognize that many variations of such embodiments exist. Such variations are intended to be within the scope of the present invention and the appended claims.

1. A recording and reproducing apparatus comprising:
at least one giant magnetic resistance (GMR) head, said GMR head comprising a spin valve element; and
a magnetic recording medium, said magnetic recording medium comprising a metal magnetic thin film formed on a nonmagnetic support member,
wherein,
surface resistivity of the metal magnetic thin film of said magnetic recording medium is in the range of 1×10³ Ω/sq.-1×10⁷ Ω/sq.,
a value of Mr·t (a product of amount of residual magnetization (Mr) and film thickness (t)) is within the range of 4 mA-13 mA, and
an amount of residual magnetization (Mr) is within the range of 160 kA/m-360 kA/m, and
said magnetic recording medium is effective to minimize noise, head saturation, and electrostatic discharge when used with said GMR head.

2. The recording and reproducing apparatus according to claim 1, wherein said amount of residual magnetization (Mr) of said metal magnetic thin film is within the range of 200 kA/m-340 kA/m.

3. The recording and reproducing apparatus according to claim 1, wherein thickness of said metal magnetic thin film is within the range of 15 nm-40 nm.

4. The recording and reproducing apparatus according to claim 1, wherein coercive force in in-plane direction is within the range of 100 kA/m-160 kA/m.

5. (canceled)

6. The recording and reproducing apparatus according to claim 1, wherein said recording medium is used in a helical scan magnetic recording and reproducing device.

7. A helical scan magnetic recording and reproducing system comprising:
a giant magnetic resistance effect (GMR) head comprising a spin valve element; and
a magnetic recording medium, said recording medium comprising: a metal magnetic thin film formed on a nonmagnetic support member,
wherein,
surface resistivity of said metal magnetic thin film is within the range of 1×10³ Ω/sq.-1×10⁷ Ω/sq.;
a product (Mr·t) of amount of residual magnetization (Mr) and film thickness (t) is within the range of 4 mA-13 mA;
said amount of residual magnetization (Mr) is within the range of 160 kA/m-360 kA/m; and
said magnetic recording medium is effect to minimize noise, head saturation and electrostatic discharge when used with was GMR head.

8. The recording and reproducing system according to claim 7, wherein said amount of residual magnetization Mr is within the range of 200 kA/m-340 kA/m.

9. The recording and reproducing system according to claim 7, wherein thickness of said metal magnetic thin film is within the range of 15 nm-40 nm.

10. The recording and reproducing system according to claim 7, wherein coercive force in in-plane direction is within the range of 100 kA/m-160 kA/m.
